(19) United States
(12) Patent Application Publication
(10) Pub. No.: US 2006/0155632 A1
(43) Pub. Date: Jul. 13, 2006

(54) Automated, user specific tax analysis of investment transactions using a personal tax profile

(76) Inventors: Rod A. Cherkas, San Mateo, CA (US); Devin W. Breise, La Jolla, CA (US); Jeffrey H. Brown, San Diego, CA (US); Elizabeth S. Cabrera, San Diego, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 09/900,485

(22) Filed: Jul. 6, 2001

(51) Int. Cl. G06Q 40/00

(52) U.S. Cl. 705/36 R

(57) ABSTRACT

An automated system provides the specific tax consequences of financial transactions of user, based on the user's particular tax profile. The system allows the user to immediately and easily determine the tax consequences of a transaction prior to execution of the transaction. The user may also determine the tax consequences of prior transactions, groups of transactions, and may between different sets of transactions.

### FIELD OF INVENTION

The present invention relates to automated systems and methods for providing tax related information pertinent to investment transactions.

### BACKGROUND

Taxes are a fact of life. Many companies and wealthy individuals invest considerable resources to reduce their tax liabilities by carefully planning their financial activities. In particular, individual taxpayers frequently hire accountants and tax preparers to prepare their taxes, and sometimes consult accountants or tax attorneys to obtain advice pertaining to the tax consequences of their financial activities, such as purchasing or selling investments. Traditionally, such advice has been limited to those who can afford such professional services. Moreover, such advice is not typically available right at the moment that an individual is considering a potential investment transaction.

With the emergence of the Internet and the pervasiveness of the personal computer two dramatic trends are emerging. First, the computer-based preparation of individual tax returns is increasing steadily. This trend includes preparation and/or filing of tax returns using either desktop based programs, or tax preparation software offered on the World Wide Web.

Second, online brokerage services have exploded in the past several years, enabling millions of individuals to trade securities online, with access to substantial support in researching the performance of potential investments.

However, to date, users of online brokerage accounts have not benefited from tax advice pertaining to their transactions. While some traders try to take into consideration the general tax effects of their trades (e.g., selling enough of a security to cover the approximate taxes on the sale), most online transactions are likely made without any sophisticated assessment of the actual tax consequences of the transaction on the individual's tax liability.

This lack of tax awareness by individual investors has resulted from several aspects of the current market structure of online brokerages and tax preparation software. First, tax advisors (accountants, tax attorneys, and like) do not typically provide brokerage services to their customers. Thus, those services and professionals who have the tax data necessary to provide tax advice for a particular transaction are not in a position to be aware of the investment transactions, let alone to integrate this information into the user's online investing environment.

Likewise, brokerage services do not provide tax advice. Investors typically do not provide their brokers or investment advisors with their tax returns, and brokers and investment advisors typically do not have access to this information. Nor do any of the current online brokerages provide any way for an individual to store and utilize their tax data in the context of an investment transaction.

This lack of tax aware guidance or advice at the time an investment decision is being made also results from the divergent distribution of stored tax data. Tax related information about a taxpayer is variously stored in different parts on the personal computer of the taxpayer, in the computer of a tax preparer, the computers of the IRS, the computers of the taxpayer's different banks, brokerages, on the servers of web-based tax preparation products, and finally the computers of the payroll service used by the taxpayer's employer.

As a result, today no single party has access to both an individual tax data and to their investment accounts at the time a trade is being contemplated. This prevents the user from easily and immediately determining the effect of a proposed or actual investment transaction on the user's total estimated tax liability. As the accurate calculation of capital gains tax rate for a particular transaction depends on the aggregation of all capital gains and losses as well as on the taxpayer's filing status and regular taxable income, it is important to incorporate all relevant tax information into any planning associated with capital gains transactions.

### SUMMARY OF THE INVENTION

The present invention overcomes the limitations of existing systems by providing an automated analysis of the tax liability consequences of a proposed or actual investment transaction by the user that takes into account the actual or forecasted tax information of the user. Generally, a tax profile stores historical and optionally forecasted tax data of the user. This information is derived from one or more of the user's prior year tax returns or from information entered directly by the user. The historical tax data includes tax filing status information, income information, deduction information, and other data as needed to compute an estimate of tax liability in a given tax year.

The user proposes a financial transaction, such as the sale of a number of securities. A tax engine accesses the particular details of the user's tax profile, information about prior related transactions (e.g., securities purchased, or cost-basis information), and computes the estimated tax consequences of the proposed transaction. These tax consequences are specific to the user's particular tax circumstances, such as their filing status, current income (or projected income), deductions, and other relevant financial transactions. In this manner, the user can assess the tax consequences prior to executing the transaction. The user may also propose and assess the tax consequences of multiple transactions.

One system embodiment of the invention includes an online brokerage system including a database of tax aware investment accounts, a tax profile database, a tax engine, and an account management system. The user accesses her tax aware investment account through the account management system to propose transactions and selectively determine the tax consequences of certain proposed transactions. The account management module further allows the user to define her tax information in her tax profile.

The invention may also be embodied in software products, particular user interfaces and workflows, computer transmissible signals that represent the information being transmitted between computers, and an online brokerage system that provides access to the user's tax profile, to their tax aware investment account, and to the tax engine.

The features and advantages described in this summary and the following detailed description are not all-inclusive, and particularly, many additional features and advantages will be apparent to one of ordinary skill in the art in view of the drawings, specification, and claims hereof.

### BRIEF DESCRIPTION OF THE DRAWINGS

FIG. 1 is an illustration of the functional architecture of one embodiment of the present invention.

FIG. 2 is an illustration of a simplified user interface for proposing a transaction.

FIG. 3 is an illustration of a simplified user interface for presenting the tax consequences of a proposed transaction.

FIG. 4 is an illustration of an alternative user interface for presenting the tax consequences of a proposed transaction using tax forms.

FIG. 5 is an illustration of a user interface for presenting the tax consequences of multiple transactions.

FIG. 6 is an illustration of a system architecture for practicing the present invention.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Functional Overview

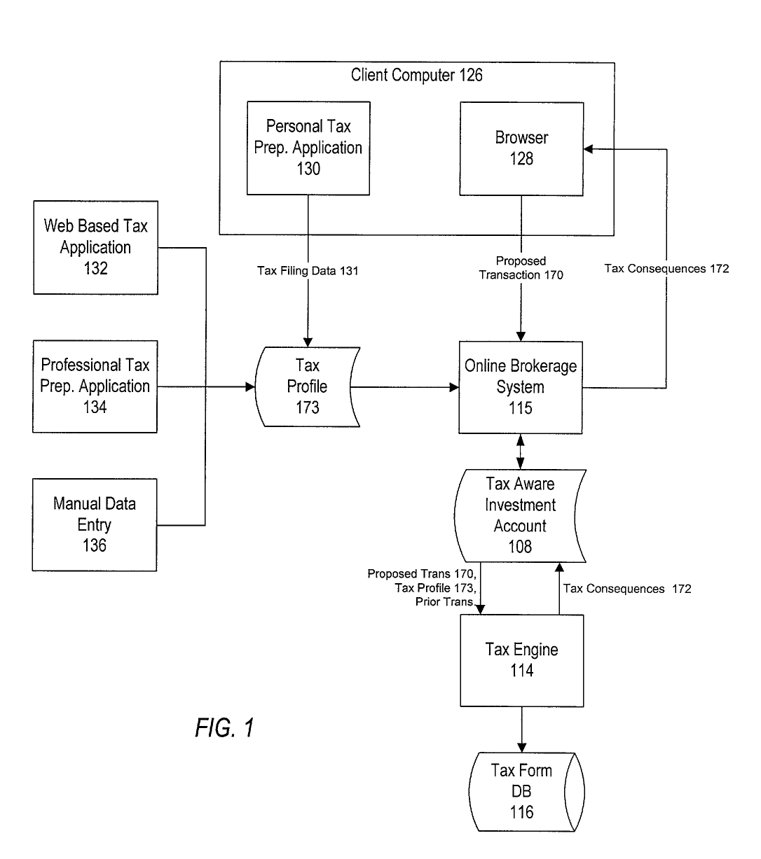

Turning now to FIG. 1, there is shown a functional overview of the operation of one embodiment of the present invention which provides to a user the tax effects on a user's total tax liability from a proposed financial transaction. To provide this information, a stored Tax Profile 173 contains historical tax data from at least one prior tax return of the user. This tax data includes non-financial information such as filing status, marital/head of household status, home ownership status, income status, marginal tax bracket, existence and age of dependents, and likelihood of owing Alternative Minimum Tax, as well as financial tax related information, such as income, deductions, losses, and so forth.

This tax information is stored in a manner that allows it to be readily mapped to the appropriate fields of relevant tax forms used to compute tax liability; e.g., income from wages may be mapped to the income fields of the various types of Form 1040, whereas income from securities sales and the like is mapped to Schedule D. The Tax Profile 173 need not store information that is not relevant to the tax consequences of an investment decision. Each user has his or her own Tax Profile 173, which is securely stored to protect the privacy of the user's tax information.

The Tax Profile 173 data can come from any number of different sources. It may be downloaded from the user's client computer 126, where it was prepared by a personal tax preparation application 130, such as Intuit Inc.'s TurboTax software application. Alternatively, it may be downloaded from a World Wide Web based online tax preparation system 132. Alternatively, it may be downloaded from a professional tax preparation application 134 used by a professional tax preparer, or it may be manually loaded via an appropriate software interface 136. It may also be downloaded from a financial accounting package or from a financial institution. Thus, there is no limitation on the source of the tax data; the only requirement is that it be available and stored in computer readable and accessible form so as to be maintained in the Tax Profile 173.

The user operates a client computer 126, including a standard web browser 128, thereby obtaining access to the Internet, and the World Wide Web. The user connects over the Web to an online brokerage system 115 that manages a Tax Aware Investment Account 108 and has access to the Tax Profile 173. The account 108 maintains data on the various individual trading accounts of the user, including the user's positions in each of some number of investments (e.g., stocks, bonds, mutual funds, options, money market accounts, and the like) and historical trading information, including the dates and amounts of each purchase or sale transaction.

The user then decides to make a transaction, such as the sale of 100 shares of IBM, which shares the user previously purchased and held. Prior to execution, this is a proposed transaction 170. A proposed transaction is one in which an investor defines a “what-if” type of scenario to estimate the outcome of a particular investment transaction. A proposed transaction or a group of proposed transactions do not alter user's Tax Profile 173, but it can be saved as potential scenario. An actual transaction, also called an executed transaction, is one in which the purchase or sale of a stock, mutual fund or other security actually takes place. This transaction does affect the user's Tax Profile 173, as the Tax Profile 173 is updated to reflect the changes to the investment history and the forecast of tax liability.

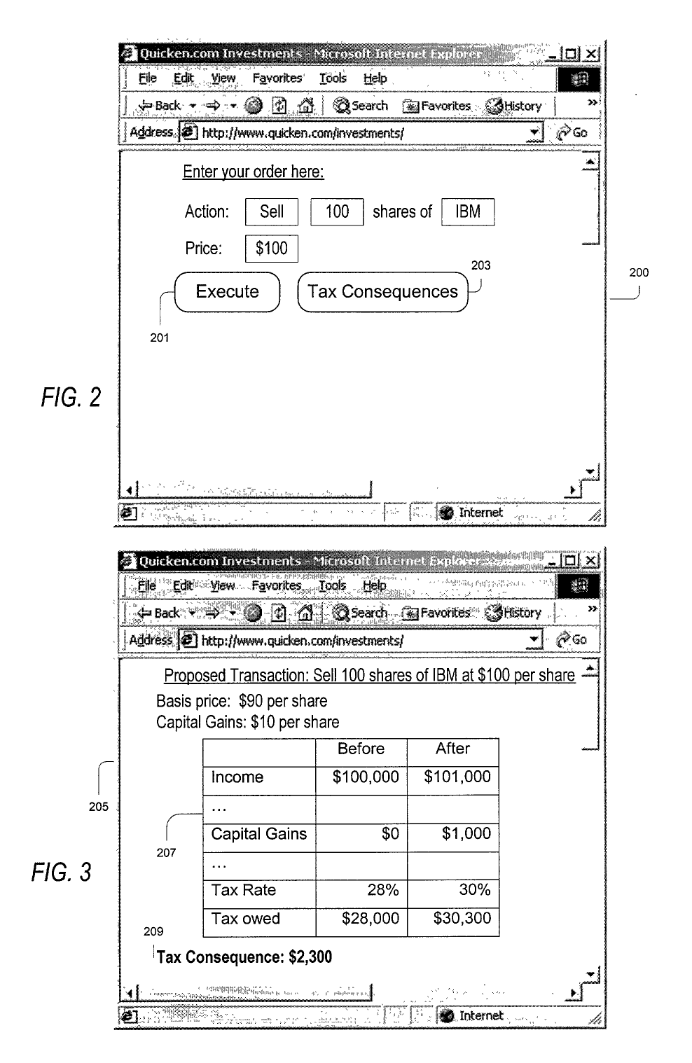

FIG. 2 illustrates, in a very simplified example, a window of a user interface in which proposed transaction is structured by the user to define the transaction type (here a sale), the amount of securities and the sale price. The user can either execute the transaction via the Execute button 201, or determine the tax consequences of the proposed transaction 170 using the Tax Consequences button control 203.

Upon the user selecting the Tax Consequences button 203, the proposed transaction 170 is transmitted from the user's browser 128 to the online brokerage system 115, and ultimately to the Tax Engine 114. The Tax Engine 114 is a functional component that is adapted to calculate a user's tax liability given the user's tax related information typically used on a complete tax return and the results of the proposed transaction.

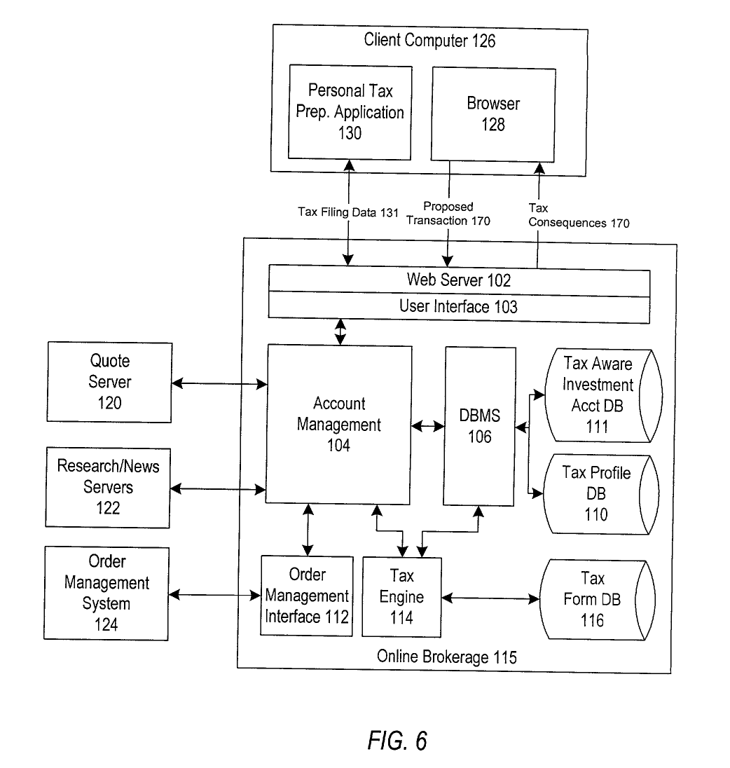

The Tax Engine 114 is in communication with Tax Profile database 110 (see FIG. 6) that stores the Tax Profile 173, and given identification data of the user, such as an account ID and password, obtains from the Tax Profile database 110 the particular Tax Profile 173 of the user. The Tax Engine 114 may also access any previously executed transactions of the user pertinent to the current tax year from the Tax Aware Investment Account 108, as these may be necessary to calculate the current or projected tax liability of the user, for example to determine acquisition dates and prices and thus determine if there has been a long or short term gain or loss.

The Tax Engine 114 is coupled to a Tax Form database 116 that contains current tax form data. The Tax Form database 116 stores a set of encoded forms, rules, objects, or any other data structures that embody the current tax law requirements, rates, and tax computations. Based on the data in the Tax Profile 173 of the user, and the particulars of the proposed transaction 170, the Tax Engine 114 obtains the appropriate forms, etc., from the Tax Form database 116, and computes the total estimated tax liability 172 of the user as a result of the proposed transaction 170. Preferably, this total tax liability 172 is the amount of total tax liability given all of the tax information of the user, such as filing status, income, deductions, and any previous transactions already completed. In an alternative embodiment, the total tax liability 172 may be the amount of marginal tax owed or saved from the proposed transaction; this marginal result is still preferably based on all of the tax information of the user, and not merely the dollar amount of the transaction and marginal tax rate. The total tax liability 172 (in either of the above formats) is then provided back to the user's browser 128 for examination by the user. If the user is satisfied, the user can execute the transaction; otherwise the user can cancel the transaction, or modify it to propose another.

The Tax Engine 114 works in a similar way to how Intuit Inc.'s TurboTax® product functions. The Tax Engine 114 calculates a person's tax liability for the relevant tax year based on all the data available. It takes information from the Tax Profile 173 for the individual and applies the tax rules and calculations as determined by the Internal Revenue Service each year. These calculations require certain pieces of data which may either reside in the Tax Profile, or may be entered manually by the user. As the data in the Tax Profile is changed, the person's estimated tax liability is recalculated. This allows the Tax Profile to be updated to reflect additional investment transactions or potential investment transactions that would affect the individual's potential or expected tax liability.

The tax liability 172 of a proposed transaction 170 may be provided to the user in comparison with the tax liability of the user absent the proposed transaction 170. FIG. 3 illustrates a sample user interface that the user may see to observe the total tax consequences. Here, the tax consequences (“After” column) are shown in comparison with the user's tax liability prior to the proposed transaction (“Before” column), showing total income, capital gains, tax rate, and taxes owed. Pertinent facts of the proposed transaction, including the number of shares, sales price, acquisition price and date, are also shown. The net tax consequence 209 is shown for the user's convenience as well to allow the user to assess the overall tax consequences of the proposed transaction. The user is provided with buttons (not shown) to execute, cancel, or modify the proposed transaction, which take the user to the appropriate screens. If the user executes the transaction, then the user's Tax Aware Investment Account 108 is updated with the relevant transaction information, and the Tax Profile 173 is likewise updated.

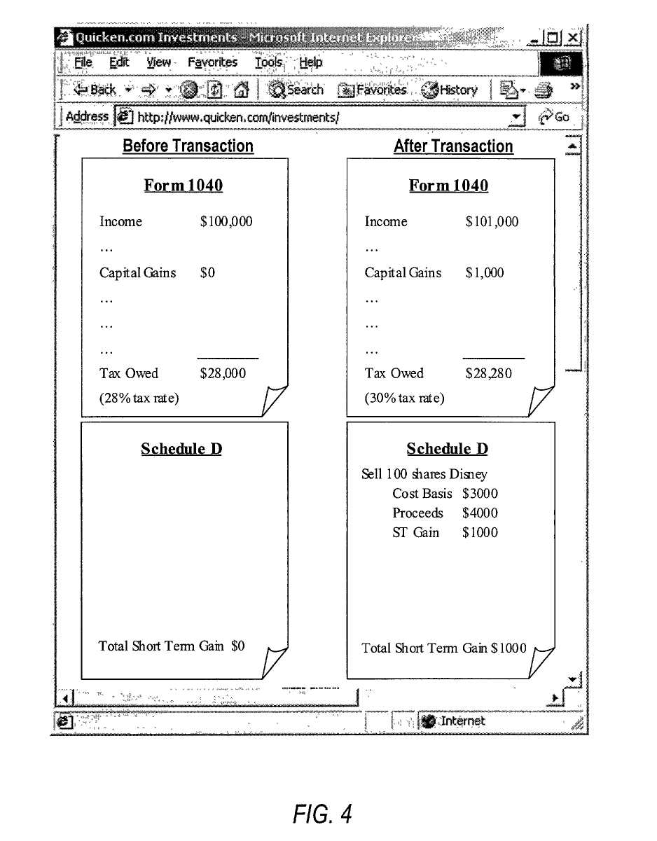

Alternatively, or in addition to the foregoing user interface, the tax consequence may be presented in “before and after” format in the context of selected tax forms, such as Form 1040 for showing income and tax liability and Schedule D for showing capital gains. FIG. 4 illustrates this type of presentation.

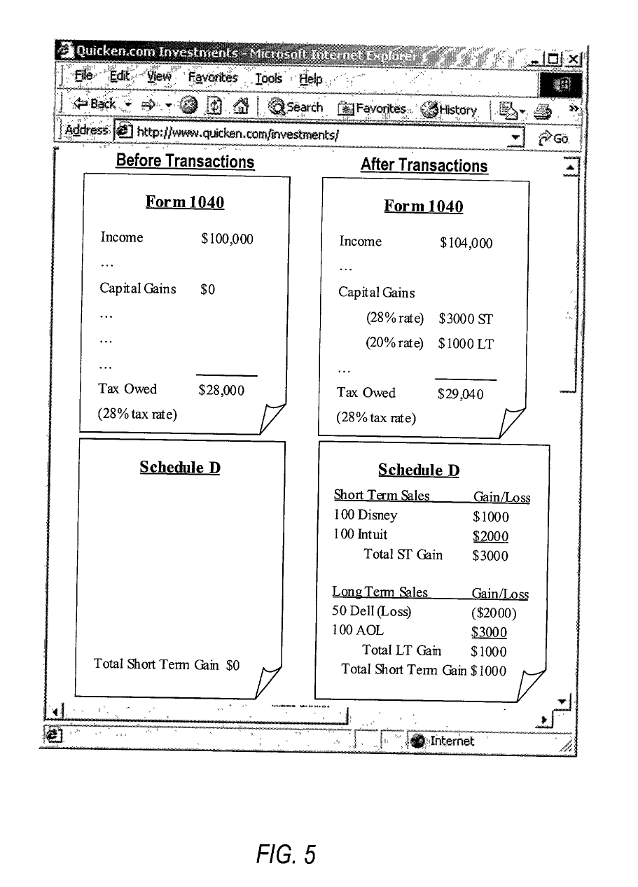

The user is also able to propose multiple transactions together (e.g., a combination of sales of different investments), or an assortment of different transactions. The user can observe the tax consequence of each alternative transaction scenario, in order to select the transaction, or group of transactions, having the best tax consequences for the user. For example, FIG. 5 illustrates (in the Tax Form format of FIG. 4) the tax consequences of a set of multiple transactions, where the user does the following:

Sells 100 shares of Disney stock for a short-tern gain of $10/share

Sells 100 shares of Intuit stock for a short term gain of $20/share

Sells 50 shares of Dell stock for a long term loss of $40/share

Sells 100 shares of AOL stock for a long term gain of $30/share

In this example, the Tax Engine 114 obtains the user's Tax Profile 173 from the Tax Profile database 110, and the basis and acquisition date of each of the stock positions from the Tax Aware Investment Account 108. From this information, the Tax Engine 114 calculates that user will owe $29,040 in taxes, based on net short term gains of $3,000 which would be taxed at a 28% short term capital gains tax rate and net long term gains of $1,000 which would be taxed at 20% long term capital gains tax rate. This is shown in comparison with tax liability of $28,000 if the transactions are not executed.

The Tax Engine 114 may also be used to compare multiple different proposed transaction alternatives. In this way the user can select the one or more transactions that have the best desired outcome, such as a specific after tax income amount or a determination of whether it is more beneficial to sell this year vs. next year. The user can set various criteria to define desired outcomes (e.g., most after tax income); the Tax Engine 114 sorts the results of proposed transactions by the selected criteria.

System Architecture

Turning now to FIG. 6, there is shown a schematic illustration of the system architecture of one embodiment of a system for practicing the present invention. Those of skill in the art will recognize that the illustration of FIG. 6 is simplified and leaves out many of the components typically present in an online system, such as mechanisms for security, fault tolerance, billing, directory services, monitoring, administration, and the like. This is done so as to focus on those features more pertinent to the description of the invention. The overall structure of the system is preferably that of an online brokerage 115, providing users with online (e.g. Internet) access to brokerage accounts, and systems for online securities and mutual fund trading. The elements of such a system are discussed with reference to FIG. 6.

The Account Management Module 104 provides the user with an interface to the normal actions of a brokerage account, including viewing the user's positions, balances, transaction history, along with mechanisms to buy and sell investment assets, and perform research and evaluation of securities. A user may maintain multiple accounts. Account access is controlled using conventional security mechanisms, including user passwords. The Account Management Module 104 interfaces with the Web Server 102 (via the User Interface 103) to receive input data (e.g., stock symbols, dollar amounts, quantities, buy/sell instructions, and the like) from the user's computer 126, via the user's browser 128. For handling transactions, the Account Management Module 104 interfaces with the Order Management System 124.

In addition to support for conventional features, the Account Management Module 104 allows a user to access the Tax Engine 114 to determine the tax consequences of a proposed transaction. When the user proposes a transaction (what-ifs) or make changes (actual transactions) to his current position (actual holdings of stocks, funds or other securities), the Account Management Module 104 invokes the Tax Engine 114 to recalculate expected total tax liability for the current tax year based on the proposed transaction, and the tax information in the user's tax profile. The forecast of tax liability can either be re-calculated based on some action taken by the individual (e.g., click a button that says “show me the tax consequences”) or it can be automatically re-calculated without requiring any user intervention.

The Account Management Module 104 also provides the user access to his personal Tax Profile 173 in the Tax Profile database 110 for editing and updating, either through manual data entry or by importation of tax data from the user's personal tax preparation application 130.

The User Interface module 103 provides the presentation layer to allow the user interact with the system. The User Interface 103 is responsible for constructing the graphical presentation provided to the client's browser 128, and receiving and processing data and commands from the browser 128 to provide to the Account Management Module 104. The User Interface 103 provides pages (or windows) to the Web Server 102, for example, using a combination of HTML, DHTML, XML, Java, JavaScript, JSP, ASP and other related technologies.

The user's Tax Aware Investment Account 108 is stored in the Tax Aware Investment Account (“TAIA”) database 111. The TAIA database 111 logically stores the Tax Aware Investment Accounts 108 for many users. Each user's Tax Aware Investment Account 108 is logically linked to the user's personal Tax Profile 173. Access to the TAIA database 111 is provided via a Database Management System 106. Any enterprise grade database system may be used, such as Oracle Corp.'s Oracle 8i. The Account Management Module 104 accesses the user's Tax Aware Investment Account 108 via the DBMS 106 to update the account as the user makes transactions, or other changes. The Tax Aware Investment Account 108 supports all types of conventional securities and assets, and transactions on such assets.

The Account Management Module 104 also provides access to the user to a Quote Server 120 and to Research/News Servers 122, The Quote Server 120 provides the user with quotes on current bids and offers on securities and other investments. The Research/News Servers 122 provide the user with access to investment research information, historical charts and analysis, and news information and news services.

The Account Management Module 104 also communicates with the Order Management System 124 via an Order Management Interface 112. The Order Management System 124 is responsible for execution of user transactions, and interfaces with conventional online trading systems to provide a user's transactions for execution.

Preferably the Tax Profiles 173 are stored in a Tax Profile database 110 physically separate from the TAIA database 111, thereby providing physical security. Likewise, the user's Tax Aware Investment Account 108 does not store information that directly identifies the user's tax profile (e.g. a profile record ID), but information that only indirectly can be used to access the Tax Profile 173. The Tax Profile 173 and the TAIA database 111 are linked together for each individual by a unique combination of the individual's social security number and their unique investment account number. This logical linking maintains the separation between the tax information separate and the investment information to protect the integrity and privacy of the tax information. This is desirable as the user may want an investment professional to be able to access and review the investment information, but not want that same person reviewing their tax information. Accordingly, restrictions on access rights may be implemented to ensure controlled access to the tax information from the user's account 108.

The Tax Profile 173 is adapted to contain tax information from multiple prior years. It may be further adapted to store tax information for future tax years as well. Information for each year is stored as a separate instance. Alternative scenarios for current or future years are also stored as separate instances within the Tax Profile database 110.

For a given user, the Tax Profile 173 maintains a base profile at all times. The base profile may be derived from data from any combination of the following: prior year tax data, current year transactions (imported or user entered), user entered data, or data calculated by the Tax Engine 114. This base profile is the starting point of most planning actions. As a year progresses and the tax related information of the user changes (e.g. changes in income, additional transactions, etc.) the Tax Profile 173 incorporates the new current year tax data. As one year ends and another begins, data for the new tax year will also be created in the Tax Profile. Prior year data will continue to be stored in the Tax Profile for use in estimating current year values or for possible comparative purposes.

The Tax Profile 173 has the capacity to store tax-related information at various levels of granularity. For example, wage income can be stored by payer or as one value for all employers; investment transactions may be stored as individual purchases and sales, or as aggregated information; deductions may be individually itemized or subtotal by relevant type or form. This flexibility makes the system adaptable to different vehicles of data collection, from import transactions to import of the prior year's tax return to high level user-entered estimates.

Preferably the Tax Profile 173 stores capital gain/loss data on a transaction level, including information sufficient to determine the acquisition price or basis, acquisition date, sale price, sale date, holding period, gain or loss, as well as other tax related information. In addition, the Tax Profile 173 allows for the storage of more generalized capital gains and losses that the Tax Engine 114 combines with the individual transactions to determine net capital gain/loss. There is one field for each holding period as well as fields for capital loss carryovers in each holding period.

Executed transactions from the Tax Aware Investment Account 108 are incorporated into a table of transactions in the base Tax Profile 173 instance as they take place. Proposed transactions are incorporated into the table of transactions in a planning scenario instance and tagged as “proposed”. The Tax Engine 114 treats them in the same way as executed transactions for the purpose of calculating proposed income tax liability.

Data is electronically imported to the Tax Profile 173 via a transfer vehicle that associates (or maps) data from the source files into categories that are compatible with the structure of the Tax Form Database 116. The Open Financial Exchange (OFX) standard is one example of such a transfer vehicle. Additional changes and calculations may be required to move the pieces of information into the proper fields of the Tax Profile 173.

The template on which the Tax Profile 173 is built is called the Tax Form database 116. The Tax Form database 116 defines the universe of fields that may hold values in the Tax Profile 173, or are required in the calculation of taxable income and income tax. The fields may be populated by electronic transfer of information such as a tax return or securities transactions from the Tax Aware Investment Account 108, by user entry, or by the Tax Engine 114, and then stored in the form of the base Tax Profile 173 or planning scenarios, depending on the circumstances. The Tax Form database 116 contains the properties of each of these fields. It will, for example, indicate the field name, whether the field is alpha or numeric, dollar or cents, the maximum number of characters allowed, and number of decimal spaces. The Tax Form database 116 is expected to require updates on at least an annual basis to adapt to changes in income tax law or to incorporate enhancements to the functionality.

The Tax Engine 114 is a computational engine that interfaces with the Tax Form database 116, the Tax Profile 173, proposed transactions (and the scenario that results). In short, it takes input from these sources, applies tax rules, and produces a revised base Tax Profile 173 or a planning scenario.

Tax rules may be incorporated into the Tax Engine 114 itself, or included in the Tax Form database 116. Tax tables and phase-out ranges, for example, are database-type items that generally require annual update. These may be found either in the Tax Form database 116 or in another database format accessible by the Tax Engine 114. The Tax Engine 114 calculations themselves represent other tax rules. For example, the Tax Engine 114 combines capital gains and losses from transactions based on holding period and then nets the resulting amounts in order to arrive at net taxable capital gain (or loss). This netting process reflects the tax rules set out by the IRS for determining taxable capital gains and losses and identifying the applicable tax rate.

If the user executes a transaction (or transactions) the Tax Profile 173 is updated. This change triggers the Tax Engine 114 to recalculate taxable income and income tax for the base Tax Profile. In the process, the Tax Engine 114 calls upon data already present in the Tax Profile 173 and calculates additional values needed, such as capital gain/loss on newly executed transactions. The Tax Engine 114 relies upon the Tax Form database 116 to define parameters for these additional values and also indicate the field name or location for storage within the Tax Profile 173. The Tax Engine 114 applies tax rules to values in the Tax Profile 173, again using the Tax Form database 116 as a guide to calculate or recalculate taxable income and income tax liability, along with all the necessary interim calculations required to arrive at those values. Taxable income, income tax liability, and any other calculated values deemed useful are written by the Tax Engine 114 to the Tax Profile 173. Once in the Tax Profile 173 these values may be accessed by the user interface, depending on the nature of the particular user session.

If the user proposes a transaction (or transactions) the base Tax Profile 173 is copied to a second file known as a scenario, to which the proposed transaction(s) is added. From this point, the same general steps are taken to calculate tax results as in the case of executed transactions, with the scenario file substituting for the Tax Profile 173. The Tax Engine 114 knows that it is operating on a proposed scenario and not the base Tax Profile 173. The Tax Engine 114 applies tax rules to the values in the scenario, guided by the Tax Forms database 116 as previously discussed. Results are written by the Tax Engine 114 to the scenario and identified as “proposed.” Certain fields are designated to contain values resulting from inclusion of the proposed transactions. Because the Tax Engine 114 knows this is a proposed scenario it writes to those fields instead of writing over the values from the base Tax Profile 173. This provides the user interface with a one-stop source for comparative information such as taxable income before/after, net capital gain or loss before/after, and tax liability before/after.

The user may choose to create additional planning scenarios for comparison. The base Tax Profile 173 is copied as the starting point and then proposed transactions are added into the mix. The Tax Engine 114 interacts with additional scenarios in the same way it interacts with the initial planning scenario.

Once values such as taxable income, gain/loss on a transaction, tax liability, etc., have been written by the Tax Engine 114 to the base Tax Profile 173 and the planning scenario, the user interface displays the values appropriate to the context of the planning session. To the extent information is available in the planning scenario the user interface can display values from that file. The user interface may also be required to access the base Tax Profile for “before” values that are no longer available in the planning scenario. A value not expected to be utilized often in the brokerage user interface, such as deductible medical expense, might become useful in a different context. User interface access to the Tax Profile allows flexibility in developing additional planning opportunities.

The present invention has been described in particular detail with respect to one possible embodiment. Those of skill in the art will appreciate that the invention may be practiced in other embodiments. First, the particular naming of the features, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the feature of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well-suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

We claim:

1. A computer implemented method of determining the tax consequences of an investment transaction, the method comprising:
storing for a user a tax profile containing tax return data for at least one tax year of the user;
accessing the tax profile of the user to obtain tax return information relevant to determining the user's total tax liability in a current tax year;
providing the user with a potential total future tax liability of the user based on a proposed brokerage transaction and the tax return information from the tax profile.

2. The method of claim 1, further comprising:
storing a brokerage account of the user in which the proposed brokerage transaction is to be entered; and
linking the brokerage account of the user to the tax profile of the user for obtaining the tax return information to determine the potential total future tax liability.

3. The method of claim 2,wherein the brokerage account is stored in a brokerage account database, and the tax profile is stored in a tax profile database that is physically separate from the brokerage account database.

4. The method of claim 1, further comprising:
determining a potential total future tax liability of the user in the absence of the proposed transaction;
providing the user the potential total future tax liability from the proposed transaction in comparison with the potential total future tax liability in the absence of the proposed transaction.

5. The method of claim 1, wherein providing the user with a potential total future tax liability of the user based on the proposed transaction and the tax return information from the tax profile, further comprises:
accessing prior completed transactions of the user relevant to the current tax return of the user; and
determining the potential total future tax liability from the prior completed transactions, the tax return information, and the proposed transaction.

6. The method of claim 1, wherein the stored tax profile comprises user's tax filing status, and income information, deduction information.

7. The method of claim 1, wherein the stored tax profile comprises user's martial status, home ownership status, and dependent information.

8. The method of claim 1, wherein items of tax return information in the user's tax profile are mapped to fields on computer representations of tax forms use to compute tax liability.

9. The method of claim 1, wherein the tax profile stores tax return information for a plurality of prior tax years.

10. The method of claim 1, wherein the tax profile stores tax return information for alternative scenarios of the current tax year.

11. The method of claim 1, wherein the tax profile stores tax return information at a plurality of levels of granularity to allow for adaptation of tax data from external data sources.

12. The method of claim 1, wherein the tax profile stores for each investment, information from which an acquisition price, an acquisition date, a sale price, a sale date, a holding period, and a gain or loss can be computed.

13. The method of claim 1, further comprising:
receiving the user's tax profile from a direct manual input by the user.

14. The method of claim 1, further comprising:
importing data for the user's tax profile from file generated by a tax preparation software application.

15. The method of claim 1, further comprising:
responsive to the user executing the proposed transaction, updating the tax profile to reflect the proposed transaction.

16. The method of claim 1, wherein providing future tax liability data to the user further comprises:
providing an amount of the total future tax liability to the user.

17. The method of claim 1, wherein providing future tax liability data to the user further comprises:
providing an amount of the marginal tax owed or saved from the proposed transaction.

18. The method of claim 1, determining a potential total future tax liability of the user based on the proposed transaction and the tax return information from the tax profile further comprises:
determining the potential total future tax liability based on the proposed transaction, the tax return information from the user's tax profile, and previously executed transactions effecting tax liability in the current tax year.

19. A computer implemented method of determining the tax consequences of a plurality of investment transactions, the method comprising:
storing for a user a tax profile containing tax return data for at least one tax return of the user;
receiving a plurality of proposed investment transactions from the user to be executed in a group;
accessing the tax profile of the user to obtain tax return information relevant to determining the user's total tax liability in a current tax year;
determining a potential total future tax liability of the user based on all of the proposed transactions and the tax return information from the tax profile; and
providing the potential total future tax liability to the user.

20. A computer implemented method of determining the tax consequences of a plurality of investment transactions, the method comprising:
storing for a user a tax profile containing tax return data for at least one tax return of the user;
receiving a plurality of separate proposed investment transactions from the user, each investment transaction to be executed independently;
accessing the tax profile of the user to obtain tax return information relevant to determining the user's total tax liability in a current tax year;
for each proposed investment transaction, determining a potential total future tax liability of the user based on the proposed transaction and the tax return information from the tax profile; and
providing the potential total future tax liability for each proposed investment transaction to the user.

21. The method of claim 20, further comprising:
determining the proposed investment transaction that has the best overall tax consequences for the user.

22. A system for determining the tax liability of a proposed investment transaction, comprising:
a tax profile database that stores for tax profiles for users, each tax profile including tax return information for a user;
a brokerage interface that receives from a user a proposed transaction; and
a tax engine that receives the proposed transaction and coupled to obtain the tax return information from the tax database, calculates the potential future tax liability of the user based on the proposed transaction and tax return information.

23. The system of claim 22, further comprising:
an account database for storing user's brokerage accounts, each user brokerage account linked to the user's tax profile in the tax profile database.

24. A user interface for a computer system that determines the tax consequences of investment transactions, user interface being provided by a computer program encoded on a computer media usable by the computer system, the user interface comprising:
a first window for receiving at least one proposed investment transaction entered by a user;
a control for executing, in response to selection by the user, a determination of the potential future tax liability of the user from the proposed transaction using tax return information of the user stored in a tax profile; and
a second window for displaying the potential future tax liability of the user, as a consequence of the proposed transaction.

25. The user interface of claim 24, wherein the second window further displays:
a total income to the user after the proposed transaction;
any capital gains or losses from the proposed transaction;
any short term gains or losses from the proposed transaction;
a tax rate applicable to the user as a consequence of the proposed transaction; and
the potential future tax liability of the user as a consequence of the proposed transaction.

26. The user interface of claim 25, wherein the second window further displays:
a total income to the user before the proposed transaction;
any capital gains or losses before the proposed transaction;
any short term gains or losses before the proposed transaction;
a tax rate applicable to the user prior to the proposed transaction; and
a total tax owed by the user prior to the proposed transaction.
